(19) United States
(12) Patent Application Publication
(10) Pub. No.: US 2014/0106674 A1
(43) Pub. Date: Apr. 17, 2014

(54) Managed spectrum control and Information system

(71) Applicants: Wojciech Maciej Grohman, Little Elm, TX (US); Darko Hadzidedic, Plano, TX (US)

(72) Inventors: Wojciech Maciej Grohman, Little Elm, TX (US); Darko Hadzidedic, Plano, TX (US)

(21) Appl. No.: 13/815,501

(22) Filed: Mar. 7, 2013

Related U.S. Application Data
(60) Provisional application No. 61/685,504, filed on Mar. 19, 2012.

(51) Int. Cl. H04W 72/04

(52) U.S. Cl. CPC H04W 72/0406
USPC 455/41.2

(57) ABSTRACT

A system for predicting the performance of and operating a robust wireless network in the managed spectrum. The system comprising of at least one Managed Spectrum Device, one wireless spectrum network access point and one Integrated Management Application.

### RELATED APPLICATIONS

This application claims benefit of and priority to Provisional Patent Application No. 61/685,504, filed Mar. 19, 2012, incorporated by reference herein.

### TECHNICAL FIELD

This application is directed, in general, to systems and methods for managing wireless communicating devices that operate in the managed spectrum.

### BACKGROUND

After completion of the analog to digital TV transition in the United States, the Federal Communication Commission embarked on the concentrated effort to allow the operation of unlicensed wireless devices in the VHF and UHF bands shared by the TV stations and other broadcast facilities. The rules for operation in the so called TV White Space were laid out by the FCC in the Second Memorandum Opinion and Order, ET Docket No. 04-186, from Sep. 23, 2010. This set of rules was the first to specify a complete set of laws governing operation of various unlicensed devices in the same spectrum shared by a number of licensed entities, such as TV broadcast facilities and microphones. This ruling marked the first such action in the world and started other rule making bodies around the world on the similar path of allowing unlicensed device operation in the spectrum shared with licensed devices.

Simultaneous operation of licensed and unlicensed devices requires new schemes of operation to allow adequate protection for the licensees and addressing these requirements was the main purpose of the said FCC ruling. What were missing from the order and subsequent discussions are the specifics of operation of unlicensed devices in a mutually non-interfering matter to take the best advantage of the new shared spectrum reality to maintain an acceptable quality of service. The invention described herein is designed to fill that void and present a suite of solutions to the managed spectrum for unlicensed and licensed devices.

New methods and systems are needed to take full advantage of the shared spectrum maximizing the total effective spectrum use and the quality of service for all devices operating in the spectrum.

While the Federal Communication Commission ruling set the precedent in terms of rulemaking worldwide, it is understood that the methods presented herein are by no way limited to the specifics of any particular FCC rules or any other rules or legislations, both in the US and worldwide, whether current, past or in the future.

This disclosure benefits from the recognition by the inventors that when dealing with license-free managed spectrum it is very difficult to establish a system that is fair to all users, namely a system that would allow for equal rights to use equal amount of wireless spectrum by its customers all the time. This is a central issue that the regulators have been grappling with worldwide and whose lack of resolution ultimately serves to hinder the development of the license-free managed spectrum.

Currently, the most successful example of freely available and license-free spectrum is provided in the US by the Industrial, Scientific and Medical Bands (ISM Bands), of which the most popular is the 2.4 GHz to 2.5 GHz band widely used by 802.11 networks (e.g. WiFi), 802.15 networks (e.g. Bluetooth, Zigbee, etc.) and others. The commercial success of these networks is partially a result of the propagation properties of the 2.4 GHz spectrum in which various building walls absorb a significant portion of the wave's energy and thus prevent long-range network interference outside of the building. In short, a 2.4 GHz band network, within a building, operating at the maximum allowed transmission power limit, is very unlikely to interfere with another similar network in the neighboring building. So, normally, there is no need to actively manage these two networks in a coordinated manner for them to operate successfully. This, however, may not always be true for other license-free networks as they may operate at frequencies that exhibit vastly different propagation properties and therefore require active management to prevent cross-network interference.

The TV White Space frequencies in particular offer propagation characteristics that allow their radio waves to travel long distances and unobstructed through many walls even at relatively very low transmission power. Managing such networks poses difficult technical, legal and commercial challenges to satisfy a basic quality of service customers come to expect when they make a significant investments in a new wireless technology.

The invention presented herein is intended to work within these existing frameworks. Rather than guarantee a certain level of quality of service in any geographical area, various aspects of this invention serve to improve the performance of the network deployed in the managed spectrum, allow the use of the spectrum on opportunistic bases, and guide the customers to understand the expected quality of service of these networks before they make a significant investment in them.

### SUMMARY

One embodiment includes a Spectrum Management Application in communication with a number of wireless devices. The SMA correlates the devices in the same vicinity and allows optimization of the communication for all networks and devices in a given area. Each said wireless device works with the SMA to ensure high quality of communication on its network.

An additional embodiment provides a device in communication with the Spectrum Management Application (SMA). The Spectrum Management Application resides on a remote server. The device works with the Spectrum Management Application to find the right frequencies to operate on and communicate with other devices in its network. The device communicates with the remote Spectrum Management Application via a communication link.

Yet another embodiment provides a system for accessing frequency allocation data for a wireless device. The system includes a wireless device communicating with the first server containing the Integrated Management Application (IMA). The system further comprises of a second server. The first server is configured to communicate with the second server via a network. The second server contains allowed frequency allocations for the device. The device retrieves the frequency allocation allowed for it from the second server by communicating directly only with the first server.

One more embodiment provides a wireless device of certain class, a first server with the IMA and a second server. The device communicates with the first server to obtain its operating parameters including frequency allocation and/or transmission schedule. The first server communicates with the second server to obtain the allowed operating frequencies for two different classes of devices from the second server. The IMA uses the data obtained from the second server to find the most optimal frequency to use by the wireless device.

Another embodiment provides a system comprising of a server running a control application, a network, a number of wireless access points operating in the managed spectrum providing the access to that network and a number of managed spectrum devices. The wireless access points serve as the network's edge to a private or public network allowing communication through that network to the private network's resources or the Internet. The managed spectrum devices use a wireless communication link to connect to said wireless access points whenever possible to download data to or upload data from the network.

One more embodiment provides a point of sale system in communication with the remote network server. The user provides the point of sale system with an address of a property. The point of sale system communicates with the said remote network server to retrieve the channel availability for various types of devices and optionally, the data on other devices operating in the vicinity at the coordinates corresponding to the said property address. Using the supplied data the point of sale system indicates likelihood of interference at the said address.

Another embodiment provides a method of manufacturing a device. The method includes configuring the device to communicate directly with a server at a specific logical location. The method further includes configuring the said server to retrieving the data for the device from a second server that contains the frequency allocation database.

### BRIEF DESCRIPTION

Reference is now made to the following descriptions taken in conjunction with the accompanying drawings, in which:

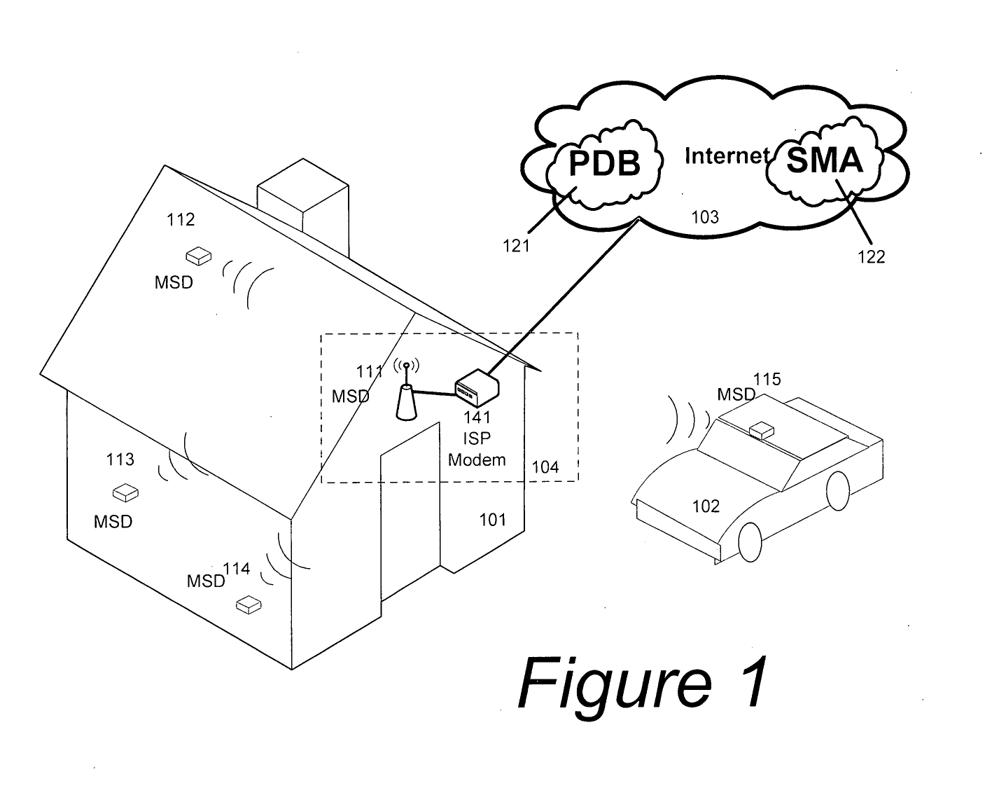

FIG. 1 illustrates one illustrative and non-limiting embodiment of a managed spectrum system with various components;

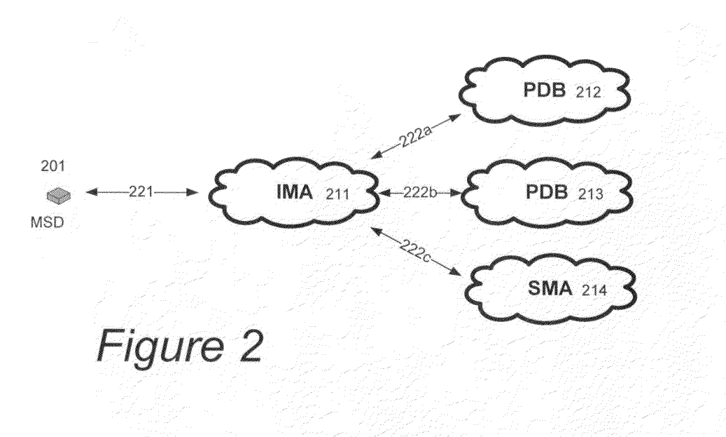

FIG. 2 presents a system including the Integrated Management Application;

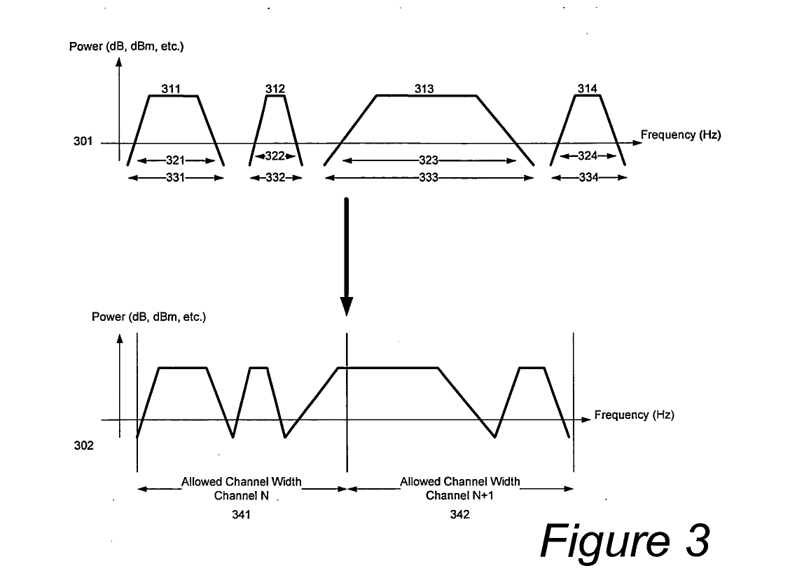

FIG. 3 illustrates example of spectrum packaging of signals with varying bandwidth;

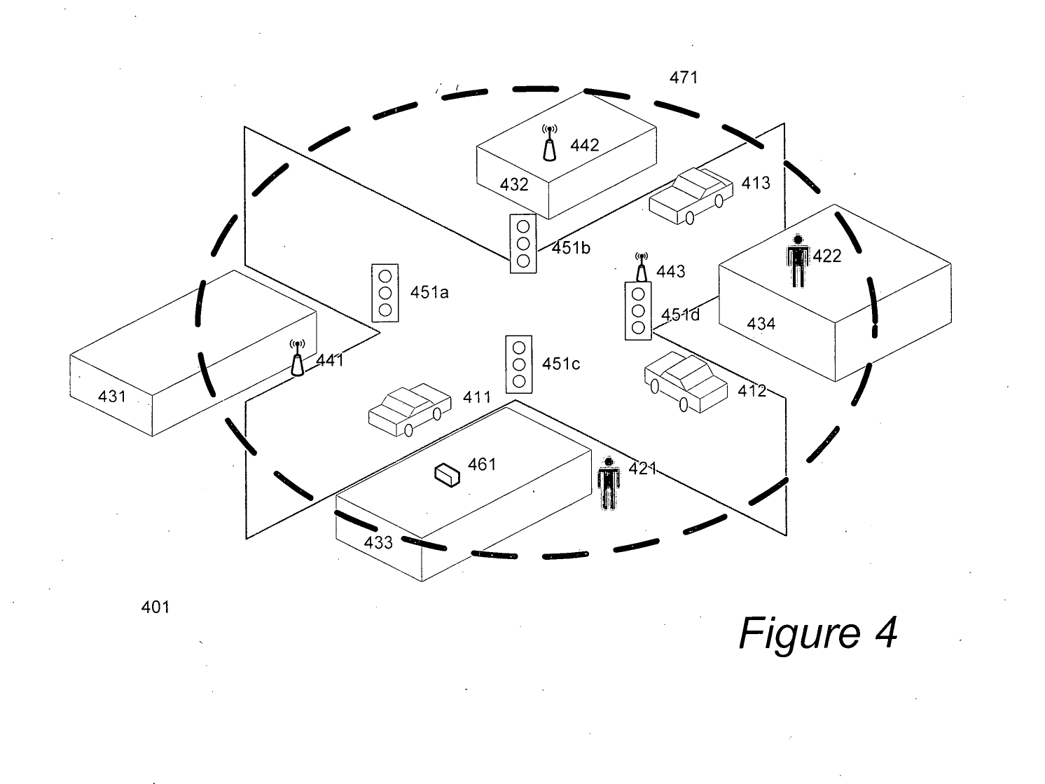

FIG. 4 illustrates without limitation example use of an opportunistic managed spectrum network use;

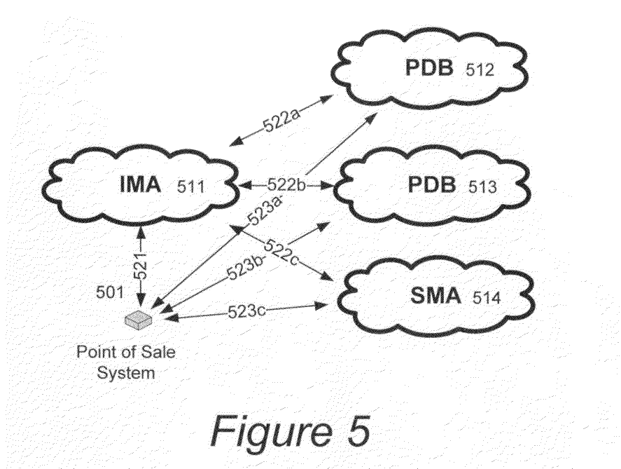

FIG. 5 shows a diagram of communications for the wireless managed spectrum Point of Sale system;

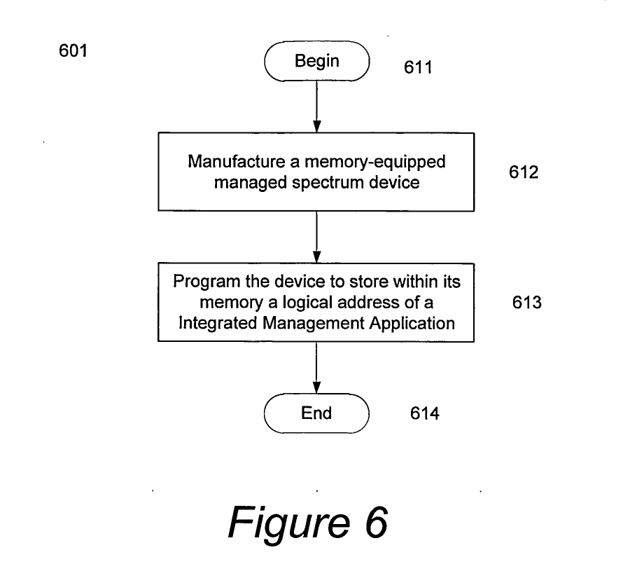

FIG. 6 presents a method of the disclosure, e.g. for manufacturing the managed spectrum device.

### DETAILED DESCRIPTION

The FIG. 1 illustrates an embodiment of a system of the disclosure in which a number of managed spectrum devices (MSDs) 111 through 115 communicate within the managed spectrum wireless network. The access point 111 serves both as the MSD and a member of a local network 104, shown here for brevity, together with the Internet Service Provider modem 141. It is understood that various local network topologies can be used including a complicated, multi-connection network with a firewall, network routers and switches and a number of redundant local and Internet connections.

As shown in the figure, the MSDs 111 through 114 are present within the building 101, while the MSD 115 is associated with a vehicle 102 thus illustrating the fact that the managed spectrum device network is free of any physical topology or application limitations.

The local network 104 connects the managed spectrum network of the MSDs to the Internet 103. It is understood that a private network or a combination of private and public (such as the Internet) networks can be used instead of the Internet without impacting the essence of the presented invention.

Within the broadly understood Internet as shown in the figure, there exist two entities Spectrum Management Application (SMA) 122 and a Protection Database (PDB) 121. The SMA serves as the control application coordinating various aspects of wireless spectrum usage by the MSDs. It can contain the current information on existing not legally protected (non-protected) MSDs active in the area, or it may retrieve this information from other SMAs. PDB contains the information about other devices whose spectrum access is currently protected—i.e. cannot be taken away or interfered with. Some of these protected devices could be protected by law (as is the case with the protected entities in the TV White Space rules), some by statue, and some by the definitions of network behavior. SMA and PDB can be merged into one application or be completely separate. They can be hosted on separate servers, or on the same server. The servers can be hosted locally by the network operator, or in the cloud.

The SMA can be wholly implemented on a single server, a combination of different servers co located or located in various different logical and physical localities, all of the possible combinations referred herein for brevity as a server. The SMA may be wholly implemented on such server, or could be implemented partially on the server and partially in the MSDs themselves. Most notably, some MSDs working on the network's edge may be allowed to make spectrum allocations on their own within their geographical range and only notifying the server about the outcome of their autonomous or semi-autonomous decisions.

The system operates continuously to enable the various MSDs 112 through 115, to communicate with the MSD 111 serving as the managed spectrum network's interface to the other networks, including the Internet. The MSDs 112 through 115 can operate on the same frequency, or on various different frequencies that share the same frequency channel or operate on different channels. The frequency of operation of each of these devices can change at any time, as decided upon by these devices working in unison with the SMA and through the MSD 111.

It is further understood that under certain conditions some MSDs (say, by the way of example MSD 113) do not communicate directly with the MSD 111, but rather use an intermediary MSD (say, by the way of example MSD 112) to relay the messages to and from MSD 111.

Turning now to FIG. 2, where a connection diagram is shown for another aspect of the invention. The figure shows the managed spectrum device 201, Integrated Management Application (IMA) 211, Protected Devices Databases (PDBs) 212 and 213 and a Spectrum Management Application 214. The MSD 201 is in communication with IMA 211 (via a communication link 221), which in turn is in communication with PDB 212 (via communication link 222a), PDB 213 (via communication link 222b) and SMA 214 (via communication link 222c). IMA 211, PDB 212, PDB 213 and SMA 214 can be located on the same server or on different ones. They can be operated together or completely independently of one another.

The operation of the system in FIG. 2 improves significantly on the operation of the system shown in FIG. 1. This is due to the redundant nature of information received from two separate protection databases. The MSD no longer relies on a single protection device database, but rather on two (shown here) or more PDBs thus greatly improving the reliability of the system. This has broad implications for the manufacturers of MSDs as they no longer have to rely on a single source of protection database information with all its technical and business risks, but rather are free to choose the information from any PDB they choose to connect to. As a result the MSDs, after they are manufactured, don't have to be updated with the new logical address of a PDB if a PDB were to change. Instead, they are programmed to access the information at the address associated with the IMA 211. This allows a great flexibility for the improvement of the system performance. The IMA works with unison with the SMA and any number of PDBs to provide the most accurate control of the managed spectrum overall, as well as for each individual MSD. As an added benefit, the system in FIG. 2 allows the MSDs to store one logical address and never have to change it, greatly improving the security of the system and making hacking into and longer-term hijacking of the MSDs more difficult.

Yet another benefit of the proposed aspect of the invention comes from the ability of the IMA 211 to extract information differences from PDBs 212 and 213. Since PDBs usually come from different and often competing sources, their data can also be different with each one of the PDBs providing some additional information on top of the minimum required. Compiling this additional information can greatly benefit the performance of the managed spectrum network of the device 201.

As a non-limiting example of a general rule, one PDB may contain additional information about interference from the protection sources and the other PDB may include more accurate information on the terrain within the vicinity of the device 201. Combining this information may lead to a more accurate network prediction model and result in different frequency and bandwidth allocations for MSD 201 than it would otherwise be possible without the extra information.

In another non-limiting example of a general rule, we consider the rules outlined by the FCC, where there are different categories of portable and fixed devices. Queried by a portable MSD, the IMA may retrieve the information from one PDB for different categories of MSDs (say one for portable and one for fixed low power MSDs) and combine the resulting frequency allocation to come up with the best frequencies for the MSD to use. As a further non-limiting example, if the allowed frequencies are on channel 30, 31 and 32 for the portable MSD and 30 and 31 for the fixed low-power MSDs, the likelihood of interference from the protected devices may be higher on channel 32, therefore the IMA may select channels 30 or 31 for this MSD to use.

It is obvious for those skilled in art that the IMA can be thought of a substitute or a particular version of the SMA discussed so far. Therefore, from now on, for brevity, we will use IMA as a general notion, referring to any combination of SMA, IMA and PDBs, except where explicitly noted.

The Power vs. Frequency graph 301 in FIG. 3, shows three example spectral densities 311, 312, 313 and 314 of example MSDs operating in the managed spectrum. In practice, the actual bandwidth of these spectral densities is shown as 321, 322, 323 and 324, respectively. This is the bandwidth that each of the devices actually occupies when communicating in the frequency band. Usually, a governing body, such as the Federal Communications Commission, Industry Canada or their other foreign equivalent, further restricts the operation of devices in any given frequency band by including side band protection for all devices. The resulting effective signal bandwidths for the three MSDs are designated 331, 332, 333 and 334 for spectral densities 311, 312, 313 and 314, respectively. Note that there can be many different types of MSDs resulting in significantly different effective signal bandwidths as shown in the figure.

One of the most important aspects of effective spectrum management is the most efficient bandwidth utilization possible. Traditionally, most regulatory bodies, especially in the TV White Space bands, operate in terms of channel assignments rather than frequency bands. This results in suboptimal spectrum usage, as two adjacent channels are not considered a uniform spectrum, but two distinct pieces of it. The invention aspect shown in FIG. 3 allows for intelligent packing of the effective spectral bandwidth of different MSDs operating in the same physical location into two or more adjacent channels, as shown by the spectral density graph 302. In this graph, the two adjacent frequency channels 341 and 342 representing channels N and N+1, respectively, are tightly packed with all four effective spectral bandwidths 331, 332, 333 and 334. As can be seen in the figure, without such tight packing the four effective spectral bandwidths would occupy more than two channels. It is an aspect of this invention that the IMA works with the MSDs to affect such effective spectrum packaging within the geographical area of the MSDs.

The intersection 401 in FIG. 4 shows a representation of a possible location of the opportunistic managed spectrum network access points 441, 442 and 443. Note that the figure shows only a representation of possible general network access point location 401 and it should in no way be considered a limiting factor. In fact, the shown general location 401 may not even be the most typical location for the managed spectrum access points, especially when dealing with suburban, rural, coastal or mountainous areas. The figure further shows buildings 431, 432, 433 and 434. These could be of any type of a building, whether private, commercial, industrial or municipal. The traffic light system 451 consists of four distinct lights 451a through 451d. It is understood that the buildings and traffic lights are shown for illustration only and are not necessarily part of the requirements for the managed spectrum network.

The vehicles 411, 412 and 413 as well as people 421 and 422 carry portable MSDs. The building 433 contains within it a non-portable MSD 461. All of the MSDs can communicate on a managed spectrum network 471 and access the broader network, such as the Internet, through any of the MSDs 441, 442 or 443 acting as the network access points. The MSDs work in unison with the IMA to connect to the Internet whenever the IMA allows for the managed spectrum connection to be active in the area. This results in an opportunistic network whose performance cannot always be guaranteed. Such an opportunistic network may have significant advantages over the existing paid networks such as a cellular network by being of lower cost and having more compelling propagation characteristics, as it is in the case of operating in the TV White Space frequency bands.

The network clients contained within 411, 412, 413, 421 and 422 as well as the MSD 461, when in the range of the network 471, use this opportunistic network, when available to upload their data to the Internet, or download data from the Internet. Although not 100% guaranteed to correctly operate at any time, the managed spectrum network 471 provides a compelling functionality for any device that does not need guaranteed low-latency network access, such as when upload its diagnostic or any logging information, or downloading firmware or software updates.

A network as described herein could be used to offload the traffic from other commercial networks, such as the cellular networks and therefore lower the average cost of usage of such cellular networks.

It is understood that the managed spectrum network 471 usually is limited in physical range, therefore resulting in the network clients, such as the MSDs contained within 411, 412, 413, 421 and 422 may come in and out of the network's range. A mechanism is therefore used to synchronize the frequencies used by these MSDs with the frequency used by the access point MSDs, such as 441, 442 and 443.

Several variants of such synchronization mechanisms exist. One involves the MSDs storing a map of the area with the location of some or all MSD access points and their frequencies. The MSD then uses this information to contact he managed spectrum wireless access points when located with their range at the specific frequencies retrieved from the maps. Since these frequencies (and sometimes locations of the access points themselves) can vary in time, the maps stored in MSDs carry a time limit on their validity. So, an MSD can contain a number of such maps for the same general location, each one representing a different subset in current or future time. Thus, the MSD, when not connected to the managed spectrum network uses its internal time keeping mechanism and its geo-location capability, such as a GPS receiver, to determine which one of the maps to use. Maps can be updated every time the MSD has the access (via the managed spectrum network or through another communication mode such as, without a limitation, a cellular network, local wireless network, e.g. WiFi, local wired network when plugged in to it, etc.) to the IMA that normally calculates these maps. The MSD equipped with such maps may then listen to access point beacons on the specific frequencies designated on these maps. These access point beacons are periodic broadcasts of a known data signal that serve to identify a particular network or a particular network access point.

Another variant of the synchronization mechanism involves the MSD scanning the network frequencies for the presence of the known beacons and responding to the beacon at the detected frequency.

To further facilitate a reliable connection of the system, the managed spectrum device acting as the access point, may broadcast the beacon on a specific sub-channel of the channel and may establish a dedicated control sub-channel to facilitate communication with other managed spectrum devices on its network. Such a dedicated control sub-channel may be the same sub-channel as the one used for broadcasting the beacon, or it may be a separate sub-channel. The control sub-channel may be used only for the local network management and may not be used for sending data not associated with the network management.

The managed spectrum network access points 441, 442 and 443 can be located in various areas of many buildings and structures. For example, the access point 441 may be located near a road or the street and housed together with some other utility access panel. The access point 442 may be located within the building 432 and the access point 443 may be located with the controller for the traffic light system 451. The shown locations also do not consider any three dimensional aspects of the invention, such as location of the access points in a multi-story, high-rise building. It is understood that many different possibilities exist for efficiently locating the access point MSDs and the presented examples shown here are for illustration only and should be in no way considered a limitation of the presented invention.

The seemingly unpredictable performance of such managed spectrum wireless network may lead to confusion of expectations for the network's customers. To rectify this issue, another aspect of the invention is shown in FIG. 5. The figure shows a Point of Sale System (PoSS) 501 and illustrates its operation in conjunction with the IMA 511, SMA 514 and PDBs 512 and 513. Note the communication link 521 from the PoSS 501 to/from IMA 511, the communication links 522a, 522b and 522c to/from the IMA 511 from/to the PDB 512, PDB 513 and SMA 514, respectively. The operation of the IMA, SMA and PDBs has been already described in another aspect of the presented invention. Note that in one variant of the invention, the aspects of the IMA can be effectively integrated into the PoSS 501 resulting in the direct communication links 523a, 523b and 523c from/to the PoS 501 to/from PDB 512, PDB 513 and SMA 514, respectively.

The PoSS 501 operates to inform the customer about expected quality of service of a set of particular MSDs in the set of locations of interest to the customer. The PoSS retrieves the data from the IMA, PDBs and the SMA to calculate the expected performance characteristics for the locations and type of MSDs of interest to the customer. The PoSS receives the information about the geographical area of interest, e.g. in the form of GPS coordinates of a polygon containing the area of interest, as well as the type of MSD required. It uses this information to retrieve from the IMA, SMA and the PDBs, the information on the frequency availability in the area of interest. PoSS 501 can also retrieve information about other MSDs currently used in the area, or the planned used of the MSDs in the future. Based on all of the information received, it derives a probability measure that defines the likelihood of certain level of performance for the MSDs in the area of question now and in the future. It can also optionally calculate the average expected bandwidth for the MSDs in question.

The information provided by the PoSS serves to inform the customer about the benefits and shortcomings of the proposed managed spectrum network. Such a PoSS could be a program running on a computer, or a computing device, physically located at a retail outlet, when selling MSDs to individual customers. It could be embodied as a server, optionally with a web-site front allowing anybody with the Internet access to assess the benefits of their envisioned network use. It could also be an application run on a PC. It can be integrated or interfaced with other networks. Generally, there are no restrictions on how the PoSS can be implemented. And while its name implies sale, the underlying idea behind it does not have to involve actual act of selling anything.

Every MSD has to logically access the IMA. It is usually done through a physical wireless connection to the managed network wireless access point, and then, from that point on, through some other wired, wireless, or a combination of both of these, connection to the Internet where the logical IMA resides. It is also possible to access the IMA through another, separate Internet connection, such as a cellular network, if the MSD is equipped to support and supports such connectivity.

The address of the IMA can be expressed in terms of its Internet Protocol address in IPv4 or IPv6 format. It can also be encoded in a form of the Uniform Resource Locator (URL). Whatever form is used, the underlying logical address of the IMA needs to be stored in any MSD.

FIG. 6 represents a method 601 of manufacturing the MSD. The method begins at step 611 and proceeds to the step 612 of actual physical manufacturing of the MSD. The method then continues to step 613 of programming into the MSD the logical address of the IMA.

It is obvious to those skilled in the arts that a logical address can be referenced to find another logical address of a resource on the network. It is understood that the step 613 provides the address to the first logical address used to find the IMA, whether the address of the IMA itself, or the address where the IMA's address can be found, or the first address in a chain of reference addresses all leading to the logical address of the IMA. After the step 613, the method terminates at the step 614.

Those skilled in the art to which this application relates will appreciate that other and further additions, deletions, substitutions and modifications may be made to the described embodiments.

What is claimed is:

1. A system for controlling frequency spectrum allocations for a plurality of managed spectrum devices, comprising:
a wireless Managed Spectrum Device; and
an Integrated Management Application.

2. The system as recited in claim 1, further comprising a network edge device facilitating communication between said wireless managed spectrum device and said Integrated Management Application.

3. The system as recited in claim 1, wherein the Integrated Management Application connects to a Protected Device Database.

4. The system as recited in claim 1, wherein the Integrated Management Application connects to at least two Protected Device Databases.

5. The system as recited in claim 2, wherein said system allows for operation of the said Managed Spectrum Device when a license-free spectrum is available for use for the said device.

6. The system as recited in claim 1, wherein said Integrated Management Application is further configured to:
retrieve the data on protected devices; and
determine a spectrum availability map that characterizes a total amount of radio frequency spectrum available to a particular type of a Managed Spectrum Device.

7. The system as recited in claim 6, wherein said Integrated Management Application is further configured to:
retrieve the data on other Managed Spectrum Devices; and
determine a certain set of frequencies available to the said Managed Spectrum Device based on that data.

8. The system as recited in claim 6, wherein said Integrated Management Application is further configured to facilitate operation of the said Managed Spectrum Device on at least two adjacent frequency channels.

9. The system as recited in claim 6, wherein said Integrated Management Application is further configured to facilitate operation of at least two Managed Spectrum Devices on the same frequency channel.

10. The system as recited in claim 6, further comprising a Point of Sale System predicting the frequencies available to said Managed Spectrum Device in a given geographical region.

11. The system as recited in claim 10, wherein the said Point of Sale System calculates the measure of quality of service for the said Managed Spectrum Device.

12. A method of manufacturing a managed spectrum network device, comprising:
manufacturing a non-volatile memory equipped managed spectrum network device; and
storing the address of the Integrated Management Application in the area of said non-volatile memory of the device.

13. The method as recited in claim 12, further comprising configuring the Integrated Management Application to control the said device via a communication link.

14. The method as recited in claim 12, wherein the said area of the non-volatile memory of the device cannot be reprogrammed after manufacturing.

15. An Integrated Management Application running on a server, comprising:
a processor configured to execute program instructions stored by a program memory; and
a data interface module defined by said program instructions that operates to retrieve information on protected devices; and
a Managed Spectrum Device interface module defined by said program instructions that operates to send data to and retrieve data from said Managed Spectrum Device; and
a radio frequency calculation module defined by said program instructions that operates to calculate frequency of operation of the said Managed Spectrum Device.

16. An Integrated Management Application as recited in claim 15, further comprising:
a data interface module defined by said program instructions that operates to retrieve information on other Managed Spectrum Devices; and
a radio frequency calculation module defined by said program instructions that operates to calculate frequency of operation of the said Managed Spectrum Device based on said information on protected devices and said information on other Managed Spectrum Devices.

17. A managed spectrum device equipped to communicate with a second managed spectrum device that provides it with the channel allocation information from the integrated management application.

18. A device as recited in claim 17, further able to request a different channel allocation from the integrated management application, based on the local conditions sensed by the device.

19. A device as recited in claim 17, where the communication with the second managed spectrum device is conducted on a control sub-channel.

20. A device as recited in claim 17, where the communication with the second device is initiated by the device upon receipt of a beacon signal from the second device.
